(19) United States
(12) Patent Application Publication
(10) Pub. No.: US 2007/0104219 A1
(43) Pub. Date: May 10, 2007

(54) System and method to facilitate testing of rapidio components

(75) Inventors: Douglas S. Jaworski, St. Petersburg, FL (US); David J. Kessler, Tampa, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/270,008

(22) Filed: Nov. 9, 2005

(51) Int. Cl. H04J 3/16

(52) U.S. Cl. 370/466

(57) ABSTRACT

A system and method are disclosed for sending and receiving RapidIO traffic to/from a RapidIO system, network or device, independent of the system, network or device. For example, a RapidIO test adapter (RTA) system is disclosed that facilitates the accessing and testing of an embedded system or device with a RapidIO interface, RapidIO network switch, and/or an entire RapidIO network. The RTA system provides a “known good” RapidIO endpoint and can issue and receive RapidIO transaction requests and responses. Also, the RTA system provides a hardware and software architecture that facilitates the programming of external systems so as to allow them to exercise control over the issuance and reception of RapidIO transaction requests and responses, without needing detailed knowledge of the RapidIO protocol or hardware used to implement the RapidIO endpoint involved. Also, the RTA system provides a plurality of independent RapidIO endpoints, which can support a wide variety of test cases without the need for additional RapidIO devices. As such, the RTA system provides physical test points on each RapidIO interface that can be used to connect an embedded system or device to RapidIO protocol analyzer hardware. Furthermore, the RTA system allows a user to manually initiate RapidIO transactions via a web-based user interface, and also uses a simple TCP/IP protocol which an external host can use to send/receive RapidIO transactions, thereby reducing the time required to program custom tests. Also, the RTA system enables RapidIO operations to be initiated by embedded software that can provide human-to-machine and machine-to-machine interfaces suitable for performing both static and dynamic tests.

### FIELD OF THE INVENTION

The present invention relates generally to the networking and communication fields, and more specifically, but not exclusively, to a system and method that facilitates testing of embedded systems and devices in a RapidIO® environment.

### BACKGROUND OF THE INVENTION

RapidIO is an architecture for a high performance, high speed, packet-switched technology used for interconnecting chips on a circuit board, and/or for interconnecting circuit boards. The RapidIO architecture was designed for embedded systems, and is used primarily for networking and communications applications. More precisely, the RapidIO architecture is designed to convey data and control information between microprocessors, digital signal processors, communications and network processors, system memory devices, and peripheral devices. For example, RapidIO may be implemented with a communication bus on a circuit card or with a backplane interconnect bus.

Notwithstanding the numerous advantages of the RapidIO architecture, a significant problem that has arisen is that there is no technology currently available that can be used to send or receive RapidIO traffic to/from an embedded system or device, which is independent of the embedded system or device. Consequently, there is no test system currently available that can be used for directly analyzing and debugging embedded RapidIO systems or devices. More precisely, there is no test system currently available that can generate, send or receive RapidIO traffic and provide test points for analyzing and debugging embedded RapidIO systems or devices. Therefore, it would be advantageous to provide a system and method for accessing and testing embedded RapidIO systems and devices, which can generate, send and receive RapidIO traffic and also provide test points for analyzing and debugging embedded RapidIO systems and devices. As described in detail below, the present invention provides a system and method for testing embedded RapidIO components, which resolve the above-described RapidIO traffic problems, testing problems and other related problems.

### SUMMARY OF THE INVENTION

The present invention provides a system and method for sending and receiving RapidIO traffic to/from a RapidIO system, network or device, independent of the system, network or device. In accordance with a preferred embodiment of the present invention, a RapidIO test adapter (RTA) system is provided that facilitates the accessing and testing of an embedded system or device with a RapidIO interface, RapidIO network switch, and/or entire RapidIO network. The RTA system provides a “known good” RapidIO endpoint and can issue and receive RapidIO transaction requests and responses. Also, the RTA system provides a hardware and software architecture that facilitates the programming of external systems so as to allow them to exercise control over the issuance and reception of RapidIO transaction requests and responses, without needing detailed knowledge of the RapidIO protocol or hardware used to implement the RapidIO endpoint involved. Also, the RTA system provides a plurality of independent RapidIO endpoints, which can support a wide variety of test cases without the need for additional RapidIO devices. As such, the RTA system provides physical test points on each RapidIO interface that can be used to connect an embedded system or device to RapidIO protocol analyzer hardware. Furthermore, the RTA system allows a user to manually initiate RapidIO transactions via a web-based user interface, and also uses a simple TCP/IP protocol which an external host can use to send/receive RapidIO transactions, thereby reducing the time required to program custom tests. Also, the RTA system enables RapidIO operations to be initiated by embedded software that can provide human-to-machine and machine-to-machine interfaces suitable for performing both static and dynamic tests.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of an example system to facilitate testing of one or more components within a RapidIO environment, which can be used to implement a preferred embodiment of the present invention; and

FIG. 2 depicts a flowchart showing an example method that can be used to implement a plurality of software instructions for an Ethernet-to-RapidIO bridge, in accordance with a preferred embodiment of the present invention.

### DETAILED DESCRIPTION OF PREFERRED EMBODIMENT

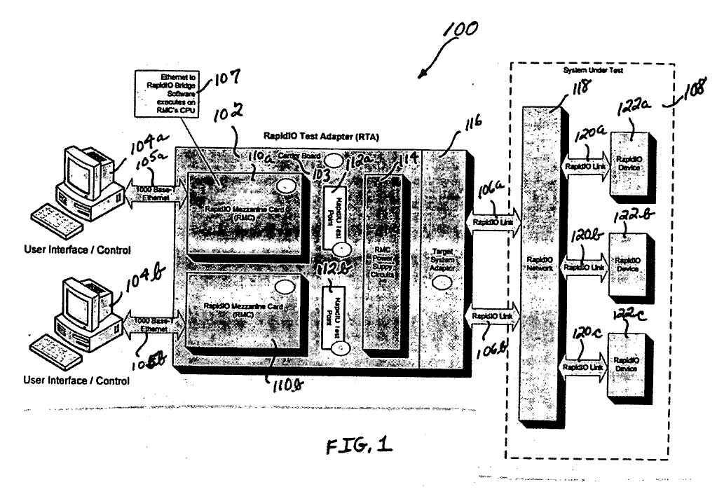

With reference now to the figures, FIG. 1 depicts a block diagram of an example system 100 to facilitate testing of one or more components within a RapidIO environment, which can be used to implement a preferred embodiment of the present invention. Essentially, the present invention provides a system and method for sending and receiving RapidIO traffic to/from a RapidIO system, network or device, independent of the system, network or device itself. In this regard, an adapter system is provided that facilitates testing of a device via a RapidIO interface, RapidIO network switch, and/or RapidIO network. For example, the device under test can be an embedded RapidIO device. The adapter system includes a plurality of “known good” RapidIO endpoints, each of which provides the ability for an external user or system to issue and receive RapidIO transaction requests and responses.

Specifically, for this example embodiment, system 100 includes an adapter system (e.g., RTA) 102. Adapter system 102 includes a plurality of RapidIO Mezzanine Cards (RMCs) 110a, 110b mounted on a carrier board 103. Notably, although two RMCs 110a, 110b are shown, the present invention is not intended to be so limited and can include any suitable number (e.g., 1, 2, 3 . . . , etc.) of RMCs, or other components that perform similar functions as an RMC. In any event, each RMC 110a, 110b includes an embedded digital processor for executing the digital functions of that RMC and adapter system 102. Also, each RMC 110a, 110b provides a RapidIO network endpoint, which can be used for generating and receiving RapidIO transactions.

For a preferred embodiment of the present invention, a suitable RMC (e.g., 110a, 110b) can be implemented using a highly integrated G8500 MPC8540-based PCI card, which is produced by GDA Technologies, Inc. of San Jose, Calif. Specifically, each such G8500 card provides a commercial, off-the-shelf single board computer system that can be configured in an RMC form factor, and includes a Freescale MPC5840 “PowerQUICC III” microprocessor with an integrated RapidIO endpoint and a 9-bit Low Voltage Digital Signaling (LVDS) RapidIO PHY. Also, each such G8500 card provides a Small Outline Dual In-line Memory Module (SODIMM) form factor Double Data Rate (DDR) SDRAM memory module (128 MiB), and a flash EPROM (16 MiB) that can be used for storing the (RMC's) operating system and application software. Furthermore, each such G8500 card provides a 1000 base-T Ethernet connection (e.g., connections 105a, 105b), which enables an operator or external system (e.g., represented by a plurality of user interface/control units 104a, 104b) to control the operations of RTA system 100, and also send and receive transactions into/from a RapidIO network (e.g., RapidIO network 118) via an existing RapidIO data communications link (e.g., 106a, 106b). Thus, for this example embodiment, an operator or external system (e.g., via a user interface/control unit 104a, 104b) can issue and receive transactions directed to/from, for example, one or more RapidIO devices (e.g., 122a, 122b, 122c) via a RapidIO network (e.g., 118) and a respective RapidIO data communications link (e.g., 120a, 120b, 120c) within a system under test (e.g., 108). For example, a typical RapidIO data communications link (e.g., 106a-106b, 120a-120c) uses a full duplex interface with an 8-bit or 16-bit unidirectional input and output at 10 Gbps using LVDS.

For this example embodiment, carrier board 103 is preferably a single Printed Wiring Assembly (PWA), which includes suitable connections that enable the concurrent installation of at least two RMCs 110a, 110b on carrier board 103. Also, carrier board 103 includes suitable power converters (e.g., RMC power supply circuits 114) that provide regulated power to the installed RMCs 110a, 110b. Notably, carrier board 103 provides a plurality of RapidIO test points 112a, 112b. As such, for each installed RMC 110a, 110b, carrier board 103 routes the RapidIO interface signals from/to an RMC 110a, 110b and a respective RapidIO test point 112a, 112b. For this embodiment, each RapidIO test point 112a, 112b includes a mating pad for a compression connector of a logic analyzer. This feature enables the use of a suitable logic analyzer to decode and display all RapidIO transactions that originate from or are routed to each RMC 110a, 110b. For example, a suitable logic analyzer that can be connected to a RapidIO test point 112a, 112b and used for test, analysis and debugging of one or more RapidIO components, is a TLA7000-series Logic Analyzer with RapidIO protocol support, which is produced by Tektronix, Inc. of Beaverton, Oreg.

System 100 also includes a target system adapter 116. Essentially, for this example embodiment, carrier board 103 routes the RapidIO interfaces from each RMC 110a, 110b to a “universal” card edge connector. In this regard, the target system adapter 116 includes a matching connector for the carrier board 103, a second connector that mates with the target system (e.g., system under test 108), and suitable circuitry to connect the target systems' components to the appropriate components on the carrier board 103. Thus, the target system adapter 116 enables the carrier board 103 and the RMCs 110a, 110b to be connected to a variety of different physical connectors (e.g., using a respective target system adapter 116 for each connection to a different target system under test).

Also, system 100 includes suitable software (e.g., identified as element 107, and described in detail below) that can be stored and executed in each RMC 110a, 110b and functions as an Ethernet-to-RapidIO bridge. For example, Ethernet-to-RapidIO bridge software (e.g., 107) enables an RMC 110a, 110b to receive a request for a RapidIO transaction via an Ethernet port (e.g., from a 1000 base-T Ethernet connection 105a or 105b) on that RMC. The RMC 110a or 110b issues a RapidIO transaction (in accordance with that received request) on the RapidIO interface for that RMC, collects a RapidIO response to that requested RapidIO transaction, and outputs that response via the Ethernet port (e.g., to the 1000 base-T Ethernet signal connection 105a or 105b). Also, the Ethernet-to-RapidIO bridge software (e.g., 107) enables an RMC 110a, 110b to receive RapidIO transactions (e.g., doorbells, message requests, etc.) on the RapidIO interface for that RMC, and forward the data derived from those transactions to the Ethernet port on that RMC. Notably, this function enables an external computer system using an Ethernet interface (e.g., without needing a RapidIO interface) to send and receive RapidIO transactions to/from a RapidIO network (e.g., 118) to which an RTA system (e.g., 102) is connected.

For this example embodiment, system 100 also includes a user interface/control unit (e.g., represented by element 104a or 104b) for each RMC 110a, 110b, which enables an operator (or external computer system) to initiate specific RapidIO transactions. For example, a user interface (e.g., via unit 104a or 104b) can be presented in the form of one or more web pages that a user can access with a suitable web browser running on a computer connected to the network to which that RMC is attached (e.g., via that RMC's Ethernet port). Preferably, only a subset of the conventional RapidIO functionality is available to a user via such a user interface. Typically, in a normal operational mode of RTA system 102, it is preferable to use an external computer system that can initiate and receive RapidIO transactions (with complete RapidIO functionality) by executing suitable instructions of the Ethernet-to-RapidIO bridge software (e.g., 107).

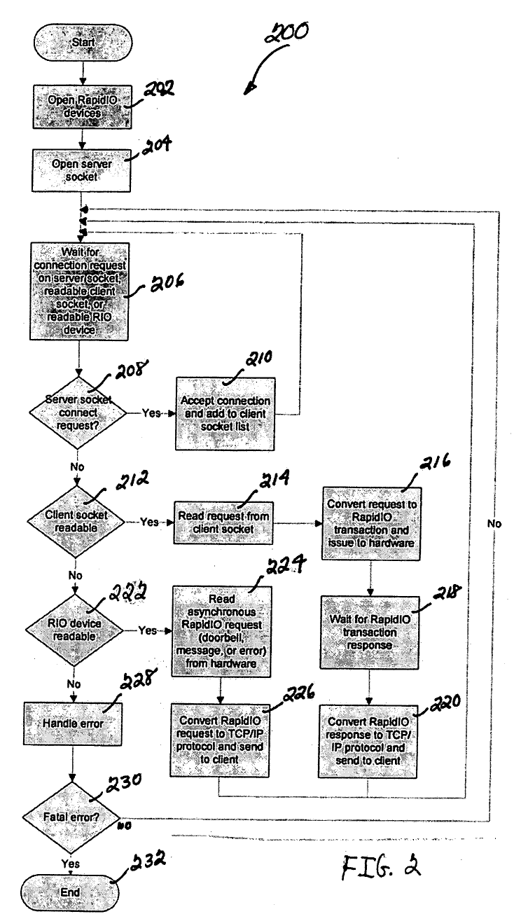

FIG. 2 depicts a flowchart showing an example method 200 that can be used to implement a plurality of software instructions for an Ethernet-to-RapidIO bridge (e.g., Ethernet-to-RapidIO bridge software 107 in FIG. 1), in accordance with a preferred embodiment of the present invention. For example, method 200 can be implemented with suitable software instructions executed by a microprocessor located on an RMC (e.g., 110a, 110b). Essentially, the Ethernet-to-RapidIO bridge software functions primarily to convert commands or instructions (e.g., test and/or maintenance read/write commands or instructions, etc.) received via an Ethernet connection to suitable RapidIO transactions (e.g., RapidIO doorbell transmission message, etc.), and to convert RapidIO transaction responses (e.g., RapidIO doorbell reception messages, etc.) to a suitable message format (e.g., ASCII text, TCP/IP, etc.) that can be conveyed to a user or external system via an Ethernet connection.

For one example embodiment, the Ethernet-to-Bridge software provides a human-machine interface that can be coupled to a standard input connection to await suitable operator commands. Preferably, each operator command is provided in the form of a space-delimited ASCII text string, which includes information about a specific RapidIO operation to be performed, a target address (e.g., address of a specific RapidIO device, etc.), and data (e.g., if applicable). The results of such a RapidIO operation are provided to a standard output connection, and the information is provided in human readable form (e.g., ASCII text string).

For a second example embodiment, the Ethernet-to-Bridge software provides a machine-machine interface that can be coupled to a TCP socket to await suitable (external) system commands (e.g., in packet form). Preferably, a command packet is provided in the form of one or more octet sequences, which includes information about a specific RapidIO operation to be performed, a target address, data length, and variable length data. A command packet header is provided to support automatic packet framing functions, and automatic recovery functions if a client communication error occurs. The results of such a RapidIO operation are returned in a response packet (e.g., via a TCP socket) in the form of one or more octet sequences, which includes information that specifies a RapidIO operation result, the data length, and the variable length data. Also, other results can be returned in a response packet, such as, for example, information associated with asynchronous RapidIO events (e.g., doorbell messages, etc.).

Specifically, in accordance with a preferred embodiment of the present invention, Ethernet-to-Bridge method 200 begins by opening suitable connections to all pertinent RapidIO devices (step 202). For example, a microprocessor in each RMC 110a, 110b issues suitable control commands to open connections and data links between the respective RMC and pertinent RapidIO devices (e.g., to one or more of devices 122a, 122b, 122c, via pertinent RapidIO links and RapidIO network 118). The microprocessor in each RMC 110a, 110b also issues suitable control commands to open a server socket associated with that RMC (step 204). For this example, the server socket(s) opened can be coupled to one or more of 1000 base-T Ethernet data communication links 105a, 105b. Next, the microprocessor in each RMC 110a, 110b waits for a connection request to be received from a user or external processing system, or from a RapidIO device (step 206). For example, a connection request can be received from an external computer (e.g., machine-machine interface) on a server socket, a user/operator (e.g., human-machine interface) on a readable client socket, or from a readable RapidIO device (e.g., RapidIO device 122a via RapidIO network 118).

Next, if a connection request is received, the microprocessor for that RMC 110a, 110b determines if the connection request was received via a server socket (step 208). If so, the microprocessor for that RMC accepts that connection and adds it to a client socket list (step 210), and the flow returns to step 206. For example, the client socket list can be stored in a memory device on that RMC. Returning to step 208, if the microprocessor for that RMC determines that a server socket connection request was not received (e.g., the server socket request now appears as a socket request on the client socket list), the microprocessor determines if the received client socket request is readable (step 212). For example, the microprocessor determines if the client socket request is provided in an acceptable (readable) format (e.g., ASCII text, packet, etc.) and includes valid operator or machine commands/instructions for one or more RapidIO operations. If so, the microprocessor reads in the request information from that client socket (step 214), converts or translates the request (command or instruction) to the form of a RapidIO transaction, and issues that request as a suitable RapidIO transaction to the designated RapidIO device or hardware involved (step 216). The microprocessor then waits for a response to the RapidIO transaction request (step 218), and converts or translates the RapidIO transaction response to a suitable format (e.g., TCP/IP, etc.), and sends the response message to the client that made the request (step 220). Thus, the response message can be returned to the user/operator or external computer system that made the request. The flow then returns to step 206.

Returning to step 212, if the microprocessor for that RMC determines that the client socket request is not readable, then the microprocessor determines if the request is a readable request from a RapidIO device (step 222). If so, the microprocessor reads in the request from the RapidIO device or hardware involved (step 224). For example, the request from a RapidIO device or hardware can be an asynchronous RapidIO request message (e.g., doorbell message, other type of message, error message, etc.). The microprocessor then converts or translates that RapidIO request to a suitable format (e.g., TCP/IP, etc.), and sends the request to a client (step 226). For example, the request from the RapidIO device or hardware can be sent from an RMC 110a, 110b to a user/interface control unit 104a, 104b via a respective Ethernet connection 105a, 105b. Thus, the ultimate recipient of this request from a RapidIO device or hardware can be a user/operator (human readable message) or external computer system. The flow then returns to step 206.

Returning to step 222, if the microprocessor determines that the request is not a readable request from a RapidIO device or hardware, the microprocessor assumes the received request is erroneous and initiates one or more suitable error handling procedures in response (step 228). The microprocessor then determines if the error is a fatal error (step 230). For example, the microprocessor can determine that an error is fatal if the error type is categorized as fatal, or the error cannot be corrected within a predetermined number of retries. If the error is determined to be fatal, then the microprocessor terminates the flow (step 232). Otherwise, if (at step 230) the microprocessor determines that the error is not fatal, the flow is returned to step 206.

Notably, the following syntax can be used to implement the above-described human-machine interface, in accordance with a preferred embodiment of the present invention (e.g., via a web page on the Internet): 1) IO Logical read (device address 1, length); 2) IO Logical write (device address 2, length, word1, word2, . . . ); 3) Maintenance read (device address 3, length); and 4) Maintenance write (device address 4, length, word1, word2, . . . ). As such, the “address” field encodes a RapidIO endpoint ID, and an IO Logical address or Maintenance address. For example, using this example syntax, assume that an operator desires to read one word (e.g., 4 bytes) from maintenance register “0x1000” in endpoint 8. The operator, using a telnet or serial console coupled to the above-described RapidIO Bridge, can enter the following command: “/dev/rapidio0 0x0000000800001000 3 4”. In response, the RapidIO Bridge (software) executes an associated RapidIO transaction and receives, for example, a value “0x1234ABCD” from endpoint 8. The RapidIO Bridge then outputs the following text to the operator's console: “0x1234ABCD”.

The following packet format can be used to implement the above-described machine-machine interface, in accordance with a preferred embodiment of the present invention. Field 1 (size—2 bytes): Preamble (“0x5a5a” or any other suitable pattern). Field 2 (size—1 byte): Type (packet type) 1) 0x00: nread; 2) 0x80: maint read response; 3) 0x01: nread; 4) 0x81: nread response; 5) 0x02: swrite; 6) 0x82: swrite response; 7) 0x03: nwrite; 8) 0x83: nwrite response; 9) 0x04: maint write; 10) 0x84: maint write response; 11) 0x05: doorbell write; 12) 0x85: doorbell write response; 13) 0x8f: doorbell received; 14) 0xff: RapidIO error. Field 3 (size—1 byte): Length (number of data bytes that follow). Field 4 (size—variable): Data (data for operation, if any). For example, using this packet format, assume that a test system desires to read one word (e.g., 4 bytes) from maintenance register “0x1000” in endpoint 8. In this case, the test system connects to the RapidIO Bridge TCP socket, and writes the following byte sequence to that socket: “0x5A 0x5A 0x00 0x03 0x08 0x10 0x00”. In response, the RapidIO Bridge (software) executes an associated RapidIO transaction and receives, for example, the value “0x1234ABCD” from endpoint 8. The RapidIO Bridge then writes, for example, the following byte sequence to the TCP socket: “0x5A 0x5A 0x80 0x04 0x12 0x34 0xAB 0xCD”.

It is important to note that while the present invention has been described in the context of a fully functioning system and method for sending and receiving RapidIO traffic to/from a RapidIO system, network or device, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular system and method for sending and receiving RapidIO traffic to/from a RapidIO system, network or device.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A system for communicating with a RapidIO device, comprising:
at least one digital processing unit;
a first data communication link, said first data communication link coupled to said at least one digital processing unit and an input/output connection for said system;
an adapter unit, said adapter unit coupled to said at least one digital processing unit; and
a second data communication link, said second data communication link coupled to said adapter unit and said RapidIO device, wherein said at least one digital processing unit is operable to:
receive a request message from said input/output connection, said request message including information arranged in a first data communication format;
convert said information arranged in said first data communication format to a request message arranged in a second data communication format; and
convey said request message arranged in said second data communication format to said RapidIO device.

2. The system of claim 1, wherein said at least one digital processing unit is further operable to:
receive a message from said RapidIO device, said message including information arranged in said second data communication format;
convert said information arranged in said second data communication format to an output message arranged in said first data communication format; and
convey said output message to said input/output connection.

3. The system of claim 1, wherein said at least one digital processing unit comprises a microprocessor arranged on a RapidIO mezzanine card.

4. The system of claim 1, wherein said adapter unit comprises a target system adapter.

5. The system of claim 1, wherein said first data communication format comprises an ASCII text format, and said second data communication format comprises a packet data message format.

6. The system of claim 1, wherein said first data communication format comprises a TCP/IP format.

7. The system of claim 1, wherein said convert operation is performed with an Ethernet-to-RapidIO Bridge.

8. The system of claim 2, wherein said message from said RapidIO device comprises at least one of a response message or a message associated with an asynchronous RapidIO event.

9. The system of claim 1, wherein said system further comprises:
a RapidIO test point coupled to said digital processing unit and said adapter unit, said RapidIO test point including at least one mating pad operable to accept a logic analyzer connection.

10. The system of claim 1, wherein RapidIO device comprises at least one of a RapidIO network, a RapidIO network switch, and a RapidIO embedded device.

11. The system of claim 1, wherein said system further comprises:
a plurality of RapidIO mezzanine cards; and
a plurality of RapidIO test points.

12. A system for communicating with a RapidIO device, comprising:
processing means;
means for communicating in a first data communication format, coupled to said processing means;
means for communicating in a second data communication format, coupled to said RapidIO device;
means for converting information arranged in said first data communication format to associated information arranged in said second data communication format; and
means for conveying said associated information arranged in said second data communication format from said processing means to said RapidIO device.

13. The system of claim 12, wherein said system further comprises:
means for receiving a message from said RapidIO device, said message including information arranged in said second data communication format;
means, coupled to said means for receiving, for converting said information arranged in said second data communication format to an output message arranged in said first data communication format; and
means for conveying said output message to an output connection of said system.

14. A method for communicating with a RapidIO device, comprising the steps of:
coupling at least one digital processing unit to a first data communication link and an input/output connection for said system;
coupling said at least one digital processing unit to a second data communication link;
coupling said second data communication link to said RapidIO device;
receiving a request message from said input/output connection, said request message including information arranged in a first data communication format;
converting said information arranged in said first data communication format to a request message arranged in a second data communication format; and
conveying said request message arranged in said second data communication format to said RapidIO device.

15. The method of claim 14, further comprising the steps of:
receiving a message from said RapidIO device, said message including information arranged in said second data communication format;
converting said information arranged in said second data communication format to an output message arranged in said first data communication format; and
conveying said output message to said input/output connection.

16. A method for communicating data between a RapidIO device and a data communication port, comprising the steps of:
opening said RapidIO device;
opening an input socket for said data communication port;
receiving, at said input socket, a connection request for said RapidIO device;
determining if said connection request includes a readable client request; and
if said connection request includes a readable client request, converting a format of said readable client request to a RapidIO transaction, and forwarding said RapidIO transaction to said RapidIO device.

17. The method of claim 16, further comprising the steps of:
receiving a message from said RapidIO device;
converting a format of said message from a RapidIO format to a format readable by at least one of a human operator or a digital processor; and
conveying said converted message to said data communication port.

18. A computer program product, comprising:
a computer-usable medium having computer-readable code embodied therein for configuring a computer processor, the computer program product comprising:
a first executable computer-readable code configured to cause a computer processor to open a plurality of RapidIO devices;
a second executable computer-readable code configured to cause a computer processor to open a server socket;
a third executable computer-readable code configured to cause a computer processor to await a connection request associated with at least one of said server socket, a readable client socket, and a readable RapidIO device of said plurality of RapidIO devices;
a fourth executable computer-readable code configured to cause a computer processor to determine if a received connection request is from at least one of said server socket, said readable client socket, or said readable RapidIO device of said plurality of RapidIO devices;
a fifth executable computer-readable code configured to cause a computer processor to accept said received connection request, if said received connection request is from said server socket;
a sixth executable computer-readable code configured to cause a computer processor to read said received request, convert said request to a RapidIO transaction, and issue said transaction to said readable RapidIO device, if said request is received from said readable client socket; and
a seventh executable computer-readable code configured to cause a computer processor to read said received request, convert said request to a client readable format, and convey said converted client readable format request to said readable client socket, if said request is received from said readable RapidIO device.

19. The computer program product of claim 18, further comprising:
an eighth executable computer-readable code configured to cause a computer processor to await a response to said issued transaction; and
a ninth executable computer-readable code configured to cause a computer processor to read said response, convert said response to at least one of said client readable format or a computer-readable format, and convey said converted response to at least one of said readable client socket or said server socket, if said response is received from said readable RapidIO device.

20. The computer program product of claim 18, further comprising:
a tenth executable computer-readable code configured to cause a computer processor to execute an error procedure, if said received connection request is associated with a non-readable one of said client socket or said RapidIO device.
